(19) United States
(12) Patent Application Publication
(10) Pub. No.: US 2004/0243464 A1
(43) Pub. Date: Dec. 2, 2004

(54) Sponsored promotions method

(75) Inventor: Mark Beck, Charlotte, NC (US)

Correspondence Address: FITCH EVEN TABIN AND FLANNERY, 120 SOUTH LA SALLE STREET, SUITE 1600, CHICAGO, IL, 60603-3406, US

(73) Assignee: Bridgetree, Inc.

(21) Appl. No.: 10/447,823

(22) Filed: May 29, 2003

(51) Int. Cl. G06F 17/60

(52) U.S. Cl. 705/14

(57) ABSTRACT

A website facilitates a co-sponsorship program that facilitates provision of consumer opportunities to property consumers. A sponsor of the consumer opportunity receives useful information from property-related services providers that identifies clients that are likely to be appropriate and appreciate recipients of such consumer opportunities. The sponsor provides identifying and acknowledging information regarding the property-related services providers when offering such consumer opportunities to consumers.

### TECHNICAL FIELD

This invention relates generally to promotions and more particularly to sponsored promotions for consumer opportunities.

### BACKGROUND

Promotions of various kinds are of long-standing known value and have been used in various ways to attract consumers to a particular purchasing venue and/or to inspire consumers to seek and purchase a particular product or line of products. For example, coupons of various kinds (including discrete coupons that are included with mailings, via a network, or at the point of making a purchasing decision as well as bundled coupons where such a coupon is combined with other offerings or materials and must typically be physically separated prior to use) are often used to facilitate the offering of various consumer opportunities. Discounts expressed as a percentage-based reduction, a reduction by a specific amount, or in some other form (including, for example, two-for-one offers and the like) are often presented to the consumer in this fashion.

When an interested consumer has ready access to such a coupon, and the coupon pertains to a consumer opportunity of relevant and timely interest to the consumer, this promotional mechanism serves all parties well. The coupon sponsor will successfully attract the consumer's business and the consumer will be availed of savings or other offered conveniences for a desired product or service. Unfortunately, perhaps more often than not, coupon-based promotions generally do little to benefit most recipient potential consumers. This poor showing results for the most part because many coupon-based promotions rely upon a widespread and relatively non-discriminating distribution of the coupons across a broad number of potential consumers. As a result, many or even most of the coupon recipients will tend to find the coupon-based consumer opportunity to be neither relevant to their needs and/or untimely (when, for example, the consumer opportunity either leads or lags an actual or potential consumer need by too much time).

These conditions can be annoying to the consumer and also contributes to considerable unneeded allocation of resources to manufacture and distribute a large number of coupons that are ultimately irrelevant or untimely for most recipients. Such conditions also contribute, of course, to increased operating expenses for the consumer opportunity sponsor.

One recent ploy by some such sponsors has been to broadcast coupon opportunities and the like via email using the Internet. While such an approach holds the potential to reduce the costs associated with the distribution of tangible coupons, such tactics have led to other problems. The transmission of unsolicited offers of product and/or service opportunities via email has, in recent times, quickly reached potentially abusive levels (earning such tactics the unflattering moniker of “spam” in the process). At a minimum, many consumers have become relatively jaded regarding the appearance of yet another irrelevant consumer opportunity appearing in their email in-box.

In some cases, marketers of a given product or service have access to more particular demographic information regarding a given consumer or group of consumers. When such information is relevant to assessing a potential need or interest of such a consumer, the information can be utilized to permit the provision of relevant and/or timely offers to such persons while also potentially avoiding providing offers less likely to be of interest to each particular recipient. While the above construct is well understood in the art, implementing such an approach presents numerous challenges.

One problem corresponds to assessing the potential relevance of a given consumer opportunity to a given potential recipient (i.e., does the opportunity in question correspond to a product or service that the potential recipient will likely find desirable; for example, a person who does not own a car is less likely to deem a consumer opportunity corresponding to automobile maintenance as being relevant to their needs). Another problem corresponds to assessing the timeliness of a given consumer opportunity for a given potential recipient (i.e., does the opportunity in question correspond to a need that the potential consumer likely has and/or perceives at the time of receiving notice of the opportunity or shortly thereafter).

For example, consumers who have recently purchased a home (either a new home or a previously owned residence) are often in need shortly thereafter of various products and services that correspond to home repairs, home decorating, home remodeling, landscaping, and so forth. Identifying such consumers, however, during a useful window of opportunity, presents a formidable challenge. For example, public records that evidence such occurrences, such as published registration of deeds within a given county, are often available only a considerable period of time after the consumer has likely been in possession of the new property. As a result, the period of time during which the new purchaser is likely to need such products and services, and therefore when such a consumer is more likely to be receptive to and appreciative of consumer opportunities that correspond to such products and services, will be more likely to have passed.

### BRIEF DESCRIPTION OF THE DRAWINGS

The above needs are at least partially met through provision of the sponsored promotions method described in the following detailed description, particularly when studied in conjunction with the drawings, wherein:

FIG. 1 comprises a flow diagram as configured in accordance with an embodiment of the invention;

FIG. 2 comprises a general site design as configured in accordance with various embodiments of the invention;

FIG. 3 comprises a schematic site page design as configured in accordance with an embodiment of the invention;

FIG. 4 comprises a schematic site page design as configured in accordance with an embodiment of the invention;

FIG. 5 comprises a schematic site page design as configured in accordance with an embodiment of the invention;

FIG. 6 comprises a schematic site page design as configured in accordance with an embodiment of the invention;

FIG. 7 comprises a schematic site page design as configured in accordance with an embodiment of the invention;

FIG. 8 comprises a schematic site page design as configured in accordance with an embodiment of the invention;

FIG. 9 comprises a schematic site page design as configured in accordance with an embodiment of the invention;

FIG. 10 comprises a schematic site page design as configured in accordance with an embodiment of the invention;

FIG. 11 comprises a schematic site page design as configured in accordance with an embodiment of the invention; and

FIG. 12 comprises a schematic site page flow diagram as configured in accordance with one embodiment of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are typically not depicted in order to facilitate a less obstructed view of these various embodiments of the present invention.

### DETAILED DESCRIPTION

Generally speaking, pursuant to these various embodiments, a sponsored website serves to receive information regarding at least one property-related services provider and to also receive information regarding at least one property consumer as corresponds to the at least one property-related services provider. The sponsored website then facilitates provision of a promotion that at least identifies the at least one property-related services provider and that also corresponds to a consumer opportunity as offered by the sponsor.

For example, the sponsored website can correspond to a commercial enterprise offering goods and/or services such as building materials, construction tools, repair tools, household appliances, landscaping tools, landscaping materials, and/or interior furnishings. The property-related service provider can comprise, for example, a realtor. In such an example, the sponsored website can facilitate provision of, for example, a discount coupon for building materials offered for sale by the sponsoring commercial enterprise, which discount coupon also presents the name and/or other identifying indicia as correlates to the realtor.

In one embodiment, the sponsored website serves to receive information from previously registered property-related service providers regarding home purchases being made by their respective clientele. Such information will generally tend to be relatively current. This, in turn, increases the likelihood that the consumer opportunity being presented to the corresponding consumer will be both relevant and timely, and hence is more likely to be noticed, appreciated, and used to the benefit of all parties concerned.

In a preferred embodiment, the property-related service provider will have a choice, at least from time to time, of a variety of consumer opportunities being offered by the sponsor to forward (or have forwarded) to a given client. So configured, personal knowledge of the property-related service provider regarding the likely needs of each individual client can be further leveraged to facilitate selection of a particular promotion that is most likely to be of interest to and benefit a given consumer.

Also in a preferred embodiment, the property-related service provider will only have access to these consumer opportunities through invitation. Such invitations can be provided without solicitation from the property-related service provider as when, for example, the sponsor has selected the property-related service provider through a vetting process of choice. In one embodiment, a facility can also be provided whereby a given property-related service provider can request such an invitation from the sponsor. Pursuant to one embodiment, when such a request for an invitation is received, the website sponsor can solicit sponsoring support on behalf of the requesting party from other property-related service providers who have already have approved access to the system.

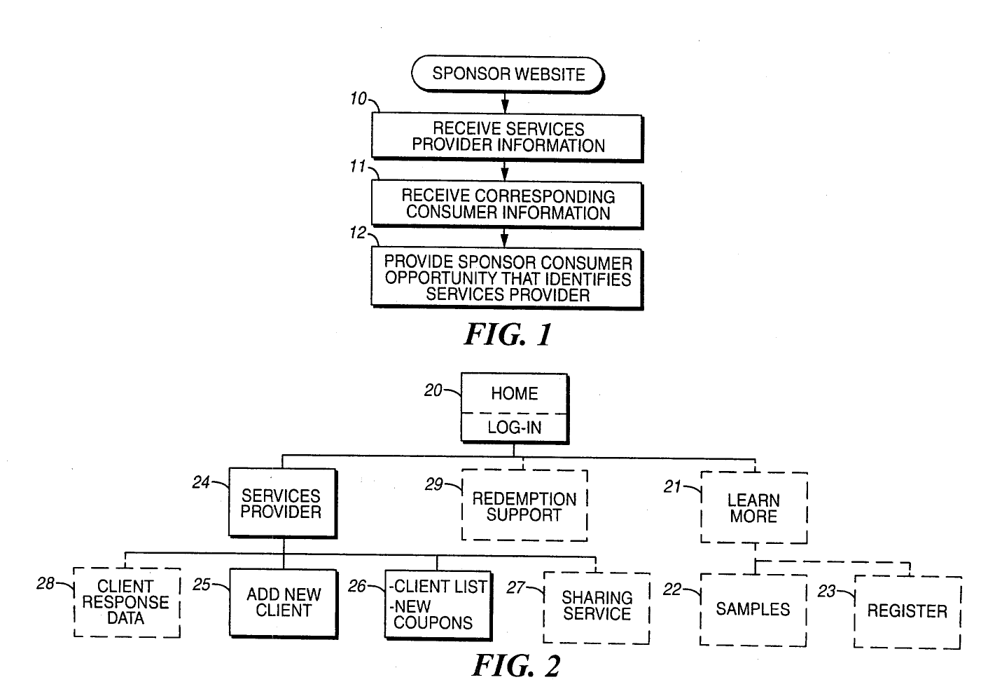

Referring now to the illustrations, and in particular to FIG. 1, a sponsor website (existing, in a preferred embodiment, on the World Wide Web of the Internet) can be configured in a variety of known (or hereafter developed) ways to essentially facilitate these basic activities: receiving 10 information regarding property-related services providers, receiving 11 information regarding property consumers as corresponds to these property-related services providers, and providing 12 a promotion offered by a sponsor (typically a sponsor other than the property-related services provider) that also identifies the property-related services provider that corresponds to the respective property consumer. (Prior art practitioners are well versed in the general mechanics of constructing and fielding such a website and hence additional details in that regard are not provided here, suffice to note that such a site can be implemented in a centralized or distributed fashion using one or more servers as meets the particular needs and requirements of a specific implementation.)

The sponsor website can be supported by one or more sponsors, and such sponsors can be competitive or non-competitive with respect to their individual offerings. For example, the sponsor website can serve the needs of only a single enterprise (or some specific portion of a single enterprise, such as a separate division or subsidiary thereof) such as a building materials supply retail establishment, a plurality of similar enterprises, or a plurality of enterprises that provide at least some non-competitive offerings (such as, for example, a building materials supply retail establishment, a yard cleaning service, a window treatment design service, and a pest control service). Further, those skilled in the art will recognize that the sponsored website could be literally designed and operated by a given sponsor such as those described above or could be owned and/or operated by one or more other parties for at least the partial benefit of such sponsoring enterprises. The concept of “sponsor website” as used herein shall be clearly understood to include these and other similar configurations and combinations.

The information received 10 at the website from the property-related services providers can encompass a wide range of information as disclosed below in more detail. In a preferred embodiment, this information includes a password or other relatively unique identifier that controls access to at least some of the features of the website by limiting such access to previously approved service providers (as also described below in more detail).

It should be clear that these embodiments are suitable for use with a wide variety of property-related services provider, including but not limited to providers of realtor services, providers of home inspection services, providers of home mortgage services, providers of home repair services, and providers of home insurance services, to name a few. Access to the sponsored website can be as limited or open to inclusion of such varied services providers as may be desired by a given sponsor.

The information received 11 at the website regarding the property consumer can include information that identifies the property consumer with respect to their status as a legal entity (such as their status as an individual, an incorporated business, a partnership, and so forth) and/or that provides address (or other location) information for the property consumer. This information can also reflect, as desired, the property consumer's status as a potential consumer (for example, as a potential customer of a provider of realtor services) or as an actual consumer (for example, as someone who has recently purchased real estate property). Other information can be received as well as appropriate to a given application and/or the unique specifics of a given sponsor. For example, in a preferred embodiment, a plurality of varied consumer opportunities may be available, and the information received 11 could therefore include selections of specific consumer opportunities to be afforded to specific corresponding property consumers.

The promotion as facilitated through provision 12 of the sponsored consumer opportunity can be realized in a variety of ways. In a preferred embodiment, the promotion includes expression of the consumer opportunity via a coupon mechanism. Such a coupon can comprise any of a wide variety of consumer opportunities, including but not limited to a specified percentage reduction in the price of a product or service, a specified price or price reduction in the price of a product or service, a two-for-one styled promotion, a sweepstakes, matching, or other chance-based contest entry or opportunity, a rebate opportunity, a complimentary gift, a complimentary demonstration, a special venue access opportunity, and so forth. Such a coupon can be tangible and/or virtual as appropriate to the given application.

As will be illustrated below, when the consumer opportunity assumes coupon form, the consumer information received 11 from the services provider can also, in a preferred embodiment, include a selection of a particular coupon notification and/or delivery mechanism. For example, a choice can be provided as between permitting the property-related services provider to have and deliver the coupon to the property consumer and having the sponsor effectively provide such coupon notice and/or access to the property consumer.

These basic provisions as set forth above can be realized in a variety of ways. To illustrate, and referring now to FIG. 2, the sponsored website can be comprised of a plurality of linked pages that facilitate these provisions in a friendly, intuitive, and logical fashion. For example, a home page 20 can serve as an initial starting point for a visiting property-related services provider.

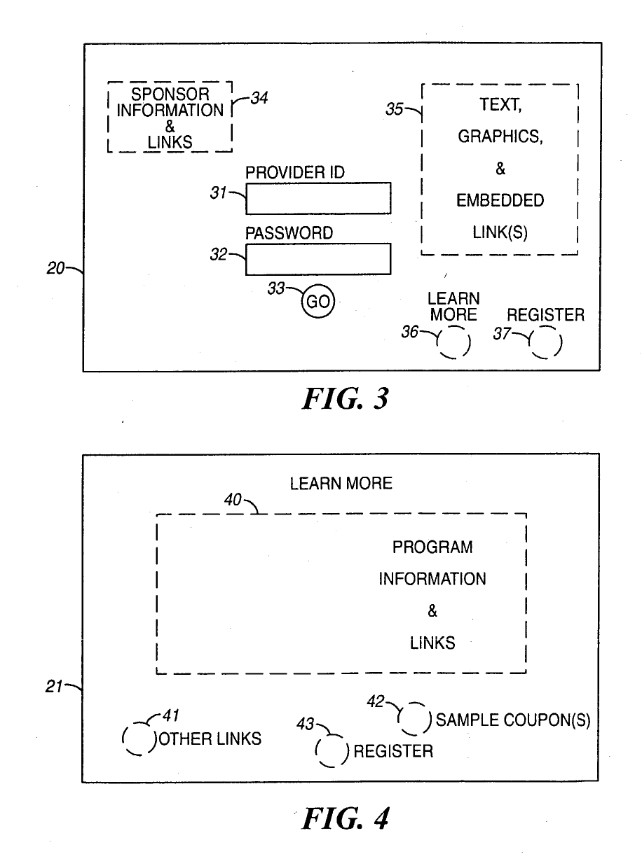

With momentary reference to FIG. 3, this home page 20 can include two alphanumeric entry fields 31 and 32 where a visiting previously registered property-related services provider can enter their provider identifier (such as their name or email address) and their corresponding password (such as a personal identification number (PIN) or other unique or relatively unique identifying information or metric (including biometric information if and as available)). A corresponding radio button 33 then permits submission of such information to the sponsor website in accordance with well-understood prior art technique. (In a preferred embodiment, the password is provided, at least initially, to the property-related services provider on behalf of the sponsor in a fashion set forth below in more detail.) If desired, other related aspects can be included on this page as well, such as, but not limited to, a link to assist the visitor when the visitor has forgotten their password (again as well understood in the art).

Such a home page 20 can also include sponsor information (including the name of the sponsor(s), trademarks and other sponsor-related logos and slogans, contact information regarding the sponsor, and so forth), and corresponding links 34 (including links to other sponsor websites, departments and subsidiaries, product and service offerings, and so forth). In addition, explanatory information 35 regarding the sponsor website itself (including but not limited to details regarding the promotion(s) program), provided via text, graphics, embedded links and the like, can be provided to provide at least an overview of the program to new visitors and/or facilitating details regarding interaction with the sponsored website, along with such other information as may be desired or appropriate in a given application. In a preferred embodiment, the home page 20 will also include specific links 36 and 37 to a page that offers additional in-depth detail regarding the co-sponsored promotions program and to another page that facilitates registration of a new property-related services provider promotions participant, respectively.

Referring again to FIG. 2, as noted above, the home page 20 can serve to link a visitor to an information page(s) 21 where the visitor can learn more regarding the promotion and/or the website itself (in addition to such other informative content as may be desired). Such an information page 21 can further link to other related pages, such as a sample(s) page 22 and a registration page 23.

With momentary reference to FIG. 4, such an information page 21 can provide program information and/or other links 40 as may be suitable and appropriate to facilitate the educational and/or training intent of the page. To illustrate, text and/or links can be provided to explain:

the need for registration;

the ability of registered services providers to utilize the website to provide coupons to their selected clients to provide those clients with preferential access to the sponsor's venues and/or to provide those clients with discounted or other favorably offered products and services of the sponsor;

who is eligible to register for the program;

whether the present visitor is pre-approved to access and utilize the website (this, for example, could comprise a link to a page at the website that would permit the visitor to enter information regarding themselves, which information the website could then use to search its records and ascertain whether the visitor already has pre-approval status);

a mechanism whereby a visitor who is not pre-approved can seek authorization to access and utilize the website (this, for example, could comprise a link to a page at the website that would: (1) permit the visitor to identify a known party who already has approved access to the website and who would be willing to vouch for and/or otherwise sponsor the visitor with respect to being granted access to the website, and/or (2) to permit the visitor to request the website sponsor to vet the standing and/or credentials of the visitor by, for example, seeking other approved parties who would be willing to vouch for and/or otherwise sponsor the visitor with respect to being granted access to the website);

and such other information as may be helpful or useful to a visitor.

Other links 41 can of course be provided as desired as well (for example, to facilitate return to an earlier page).

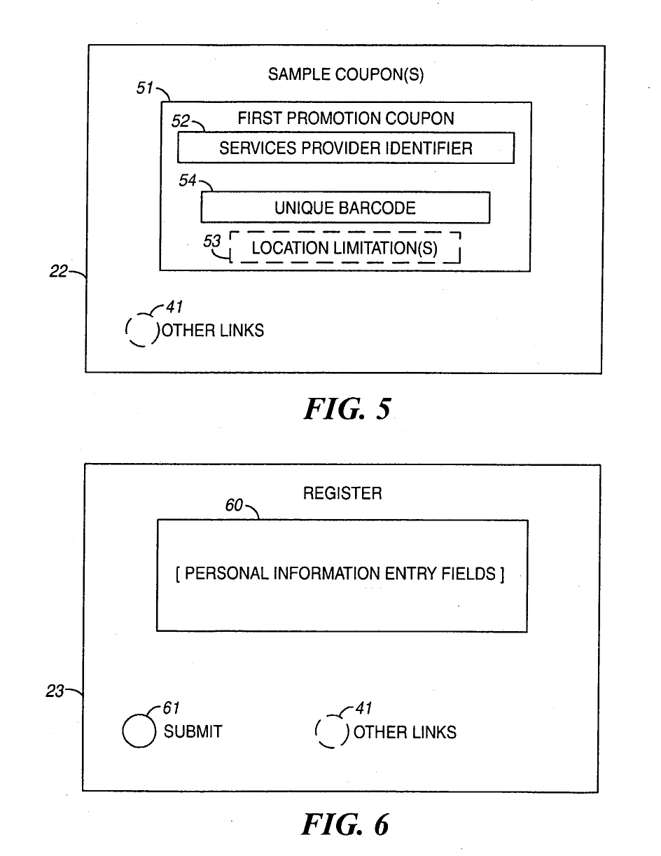

In a preferred embodiment, a link 42 is provided to permit the visitor to access and view at least one sample of a consumer opportunity delivery platform that corresponds to the consumer opportunity being facilitated by the website. For example, when the consumer opportunity includes provision of a coupon, this link 42 can serve to present a sample coupon for the visitor's perusal. For example, and referring momentarily to FIG. 5, this sample page 22 can include a graphic depiction of a coupon 51 as pertains to a first promotion (such as a percentage-based or other monetary pricing discount of products offered by the sponsor). In a preferred embodiment, the sample coupon 51 includes information 52 that identifies a given property-related services provider to illustrate for the visitor that a resultant coupon as fashioned via the sponsored website will be presented to a recipient consumer as a consumer opportunity that bears the identifying information for a referring property-related services provider.

If desired, this coupon 51 can also include location information and/or location-based limitations 53 that pertain to redemption or other usage of the coupon by a recipient consumer. For example, processed coupons for a specific recipient may be limited to usage at only specified sponsor venues. Or, in the alternative, the coupon may simply identify one or more specific sponsor venues that are geographically convenient to the recipient.

Also, in a preferred embodiment, the coupon 51 also includes a unique characteristic such as, for example, a unique barcode 54 that uniquely identifies a given coupon as correlating, for example, to a specific identified recipient, property-related services provider, sponsor venue(s), and/or specific consumer opportunity (such a barcode could include, if desired, a check digit feature as known in the art to facilitate determining when a given coupon has been previously redeemed). So configured, the sponsor or other interested party can control, if desired, the number of times that the coupon offer is used (for example, the specific consumer opportunity that correlates to the unique barcode 54 can be limited to a predetermined number of uses, such as one-time-only usage). Such a configuration can aid in discouraging or preventing inappropriate activities such as the unauthorized usage of photocopies of the original coupon. Such a service can be supported via an independent platform (or platforms) or can, if desired, be supported by the present website when acting as, for example, a redemption facilitation server. For example, as provided in FIG. 2, a redemption support capability 29 can be optionally incorporated into the sponsored website to:

receive such identifying information when and as presented at the point of sale,

compare the received identifying information with stored information regarding previously offered and redeemed coupons;

provide authorization to accept the presently tendered coupon or to reject the offer (as being, for example, a duplicative tendering of a previously accepted coupon).

And, of course other links 41 and/or other informational content can be included as desired and as otherwise is well understood in the art.

Referring again to FIG. 4, the information page 21 can also provide a link 43 to a registration page 23 to permit and facilitate registration of a new property-related services provider for participation in the offered promotion(s). To illustrate, and referring now to FIG. 6, such a registration page 23 can include a plurality of personal information entry fields 60 to permit (and/or to require) entry of information such as the first name, middle initial(s), and last name of the applying property-related services provider, their mailing address (including street address, suite or apartment number, city, state, country, and zip or other relevant postal code), one or more telephone numbers (including alternative telephone numbers such as facsimile reception telephone numbers), one or more email addresses as desired, and information to characterize the services offered by the party seeking registration when registration is open to more than one kind of services provider. (In a preferred approach, known double-entry mechanisms can be used to ensure the accuracy of at least some of these items such as, for example, an email address.) Other entry fields 41 can be used to permit or require entry of other information of interest as well, and a submission mechanism 61 can serve to permit submission of entered information to the sponsored website (to thereby permit local and/or remote processing of some or all of such information as understood in the art).

Pursuant to one approach, the registration process can be conducted in real (or near real time) such that a successful registration can be communicated to the visitor before they likely exit from the registration page 23. It is also possible to communicate at the same time a system access password to the visitor, though in a preferred embodiment such a password will be communicated via other means (such as by sending the issued password to the visitor by using the email address as represented by the visitor when registering with the system).

So configured, a visiting party can both receive educational and/or training information regarding the sponsored website, the sponsor, and/or the promotion(s) being facilitated via the website and can themselves provide information to facilitate their registration and subsequent participation in the offered co-sponsored promotional activities.

In a preferred embodiment, at least some information regarding a potential participant can be gleaned in other ways and utilized to pre-approve and at least partially pre-register such potential participants. A corresponding password can then be forwarded to the potential participant (via email, for example) to prompt and permit such a recipient to log-in to the system. So configured, at least some of the previously obtained information can be presented in the corresponding data entry fields during the registration process to thereby avoid the need to have the registrant enter such information.

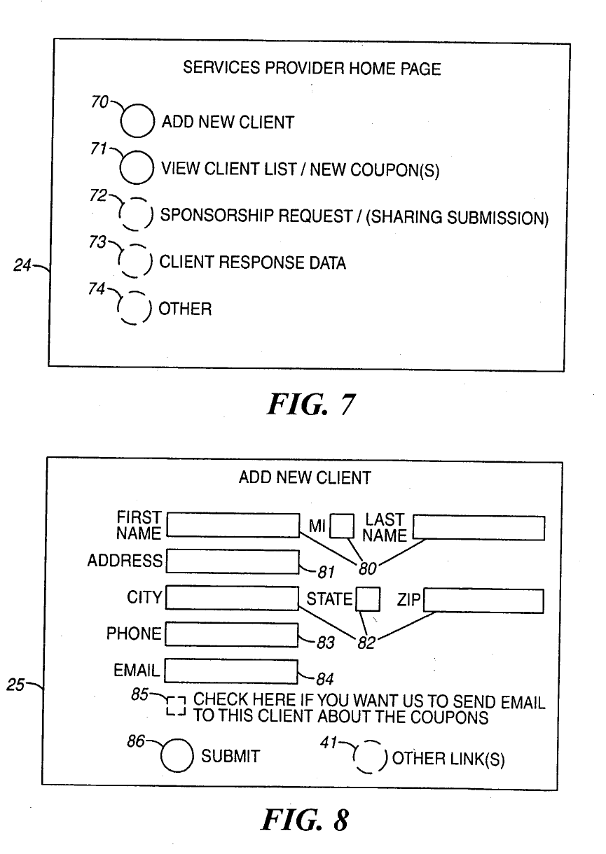

Referring again to FIG. 2, as noted above (and as described with respect to FIG. 3), the home page 20 can serve to log-in a visiting property-related services provider and then link a confirmed authorized visitor to a services provider home page 24 (or other site area where the segregated services are supported). With reference to FIG. 7, such a services provider home page can provide a variety of links to afford access to various desired actions and/or information. For example, links can be provided to facilitate entry of new client information 70, to view an existing client list (and/or to facilitate provision of a consumer opportunity offering to an existing client) 71, to facilitate responding to sponsorship requests for other property-related services providers (and/or to optionally facilitate sharing the website service with other property-related services providers by permitting this provider to submit identifying information regarding one or more candidates for the service) 72, to review client response data 73, or to access any other action or information as may be desired or appropriate 74 (for example, to facilitate changing one's own personal information including items such as one's email address, password, and so forth and/or to permit the user to log-off from the system in an orderly fashion).

With reference to FIG. 8, a page 25 to permit addition of information regarding a new client (such as a property consumer or potential property consumer) can include entry fields for various kinds of personal information including name 80, street address 81, city, state, and postal code 82, telephone number 83, and email address 84 for the new client. A submission mechanism 86 permits submission of such information, once entered, to the website. And again, other links 41 can be provided as desired. In a preferred embodiment, the promotion(s) facilitated via the website include consumer opportunities that are capable of being provided to a recipient property consumer in more than one way. For example, the website can permit a given coupon to be printed by a property-related services provider and then physically provided by the latter to a corresponding property consumer (for example, via ordinary postal delivery or by hand delivery). Another selectable option 85 is preferably to permit the property-related services provider to select automatic delivery of the consumer opportunity mechanism to the property consumer (via, for example, email). So configured, a given property-related services provider can customize the mode of delivery to likely optimize the likelihood that a given property consumer will receive, understand, appreciate, and take advantage of the consumer opportunity.

If desired, other kinds of information can be requested via this registration page 25. For example, both a current mailing address for the property consumer can be sought as well as the address of property that the consumer has recently acquired. As noted earlier, it is possible to limit the consumer opportunity to one or more specific sponsor venues (or to at least advise the recipient consumer of convenient locations where the consumer opportunity can be realized). Information regarding the location of the property that the consumer has recently acquired (or is acquiring) can be used to facilitate an informed selection of such venues to better serve such purposes.

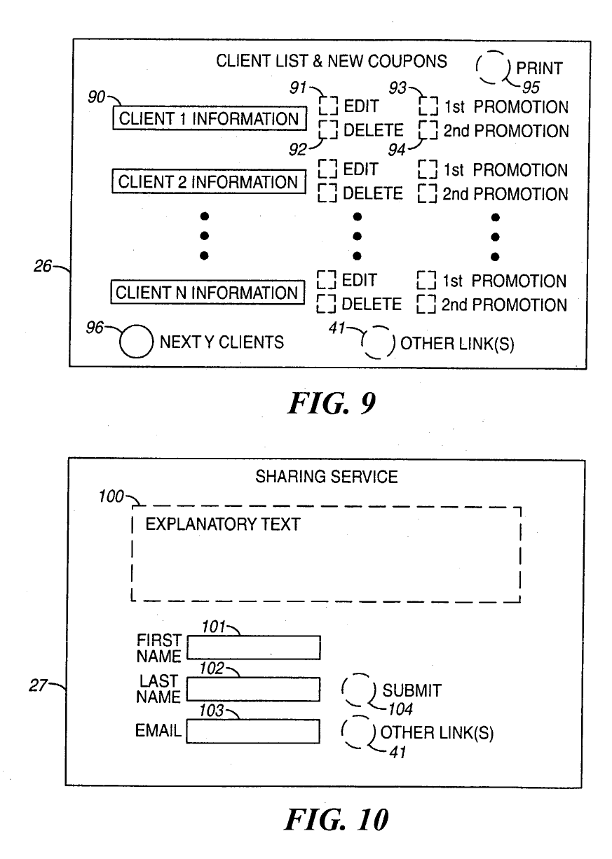

Once a given client has been registered, the property-related services provider can then utilize the website to identify one or more different consumer opportunities to be communicated to that client. In a preferred embodiment, a page 26 serves to facilitate such activities. With reference to FIG. 9, identifying information for one or more previously registered clients 90 can be displayed (such information can be as desired, and will typically include at least the last name of each client). In a preferred embodiment, an edit 91 and/or delete 92 capability will be provided to permit the property-related services provider to edit the personal information for the corresponding client or to delete that client's information, respectively. Another selector capability 93 can serve to permit selecting a given promotion to be offered to the corresponding client. In a preferred embodiment, a plurality of such promotions are offered at any given time, such that each promotion can have a corresponding selection capability (two such promotions are illustrated in FIG. 9 to suggest this configuration, with each such promotion having a corresponding check-box 93 and 94, respectively, to permit selection of one and/or the other promotion for a given client). So configured, the property-related services provider can readily match a given available consumer opportunity to a given client.

As with all of the illustrative pages described herein, numerous alternative approaches are of course possible. Here, for example, each promotion indicia can include a further indicator (not shown) to provide information as to when a particular promotion has already been previously provided to a given client. As another example, the promotion indicia itself can comprise a link to additional information that describes that particular promotion in more detail (including, for example, information regarding any pertinent limitations that may potentially encumber the opportunity, such as when a given consumer opportunity is limited to only certain geographical areas that may be inconveniently located for a given client). As another example, the listing of clients 90 can be provided on a single page with access to all clients being achieved through scrolling, or the listing of clients 90 can be parsed over more than one page, with access to each subsequent page being achieved with a next-page selector 96. As yet another example, a search capability can be provided whereby a property-related services provider can enter identifying information for a particular client (or clients) and the system will search for matches within the client information. As yet another example, the system can provide an indicator when a given client has already been provided a given consumer opportunity by, for example, another property-related services provider to thereby prevent or discourage providing a given property consumer with multiple redundant offerings from different services providers.

As noted above, it may be desirable to permit a participating property-related services provider to recommend and/or share the co-sponsoring program with other services providers. A page 27 can serve to facilitate this capability as illustrated at FIG. 10. Explanatory text 100 can be depicted to explain the process and/or to provide information regarding incentives for sharing the service. Information entry fields can be provided to receive identifying information for the property-related services provider being identified (for example, fields are preferably provided for the first name 101, last name 102, and email address 103 of the property-related services provider being identified). A submission mechanism 104 serves to provide the entered information to the system for processing. So configured, the system can receive and then utilize such information to permit such identified persons to be automatically contacted (via, for example, email) and provided with information regarding the co-sponsored promotional activities being facilitated by the website.

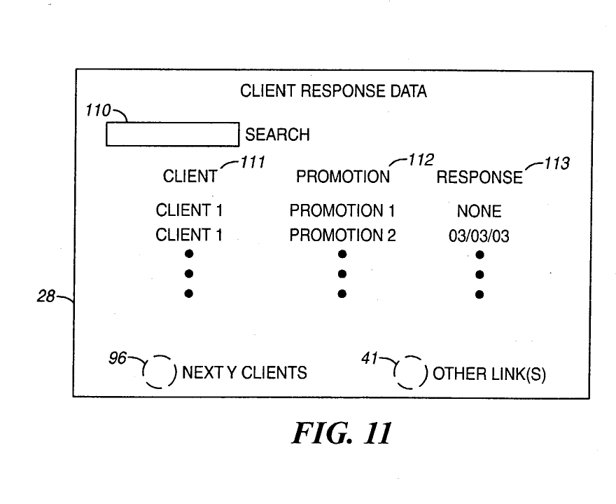

In some instances, it may be desirable to provide registered property-related services providers with information regarding use of the consumer opportunities being offered by the system. As noted above, a page 28 can be provided to facilitate the provision of such information. With reference to FIG. 11, a search field 110 can be used to permit a property-related services provider to locate a specific client of interest. In addition, or in the alternative, all clients 111 can be listed (for example, in alphabetical order by last name, in order of chronological entry, as grouped by geographic area, or by whatever other sorting or ordering criteria may be desired and/or appropriate to a given application) with the corresponding promotions 112 that had been offered to them and their apparent response 113. Usage of the consumer opportunity can be tracked when the opportunity is facilitated via a unique number or code that correlates a given intended recipient to a specific opportunity as described above. Accordingly, information regarding date of usage and/or non-usage can be readily gleaned and presented when desired.

So configured, consumer opportunities can be selected for submission to a given consumer as based upon subjective relevancy criteria within the knowledge of the property-related services provider. The consumer opportunity itself is further relatively likely to be offered to a given consumer at a time when that opportunity is relevant to the potential needs of the consumer. Further, the property-related services provider's participation in the promotional program, while of obvious benefit to the sponsor, is also acknowledged via the co-sponsoring acknowledgments that are incorporated into the presentation of the consumer opportunity. Since the consumer opportunities being offered are likely to be relevant to the consumer, they are likely to be appreciated by the consumer. This appreciation inures in turn in part to the benefit of the property-related services provider via this co-sponsorship. As a result, the sponsor, the property-related services provider, and the consumer all benefit significantly.

Since the consumer opportunities afforded via these embodiments are preferably associated with a corresponding unique identifier, it would be relatively simple to track the resultant redemption activity. For example, when a particular consumer presents a general ten percent-off coupon at a given retail establishment a record can be retained of the specific purchases made by the consumer in conjunction with that coupon. Such information can be stored in a database (either locally and/or remotely) and used alone or in combination with other related information to develop a better understanding of particular products that appeal to this given consumer. Such information can in turn be utilized to facilitate subsequent offers that are likely to be of interest to this particular consumer.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

For example, in the embodiments set forth above, the consumer opportunity is expressed as a coupon. These teachings are likewise applicable to other opportunity vehicles as well, however, including but not limited to the establishment, offering, and administration of so-called frequent buyer (or other loyalty) programs. Furthermore, as well understood in the art, there are various ways to achieve the effective actions, content presentation, and information submission and retrieval activities described above, and such alternative mechanisms and approaches are expressly understood to be within the ambit of these teachings.

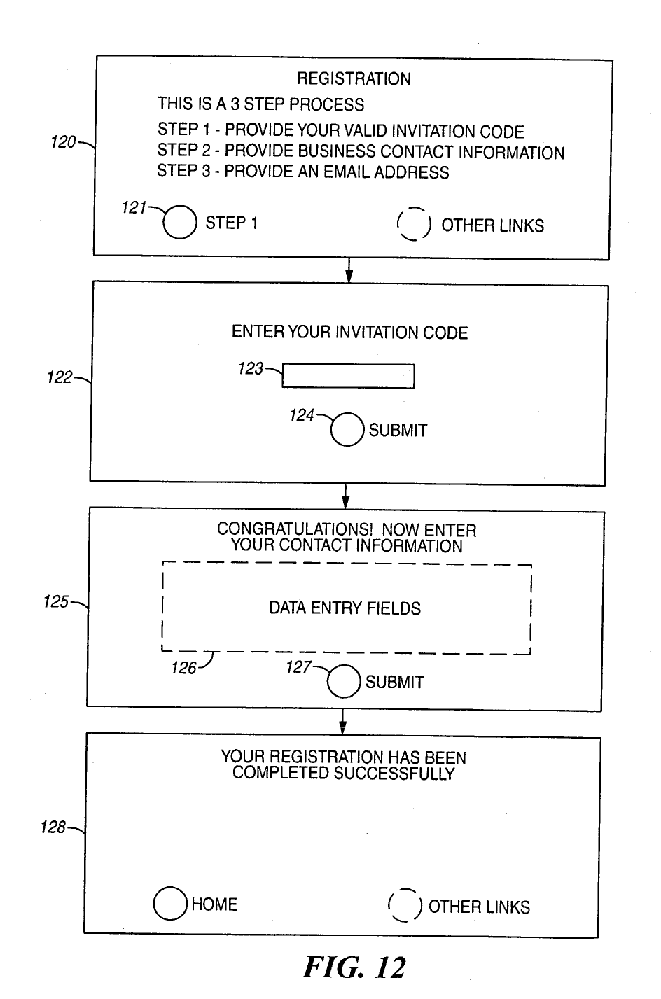

It would also be possible to parse some of the above-described activities over a plurality of sequential pages. For example, and referring now to FIG. 12, the registration process can be subdivided into a plurality of steps that are individually accommodated on discrete pages of the website. To illustrate, a first page 120 can provide explanatory information to the visitor regarding the registration process (such as, in this example, by explaining that the process comprises a three step process. A link 121 can serve to move the visitor to the first step at the visitor's convenience. At a second page 122, a first part of the registration process can require that the visitor enter their invitation code into a corresponding data entry field 123 as previously received from the website sponsor (via, for example, email). Upon submitting this information (via a submit link 124) a third page 125 can inform the visitor of their successful participation in the registration process so far and can then solicit the entry of the visitor's contact information in various corresponding data entry fields 126. (In addition, if desired, previously obtained contact information can be presented in the appropriate field(s) to permit the visitor to confirm and/or correct such information as appropriate.) Upon submitting this information (again via, for example, a submit link 127), a final page 128 can be presented to inform the visitor of their successful completion of the registration process.

It should also be evident that this approach can be extended to situations other than to service providers with respect to the conveyance of real property and associated consumers. Other service providers are potentially privy in a similar fashion to potentially early information regarding the activities and life events of their clientele. Therefore, in a similar fashion as presented herein, such service providers could also participate in a process to provide relevant and timely consumer opportunities to their own clientele.

We claim:

1. A method comprising:
receiving at a sponsor website information regarding at least one property-related services provider;
receiving at the sponsor website information regarding at least one property consumer as corresponds to the at least one property-related service provider;
providing a promotion that:
at least identifies the at least one property-related services provider; and
corresponds to a consumer opportunity as offered by a sponsor of the sponsor website.

2. The method of claim 1 wherein the sponsor of the sponsor website comprises a commercial enterprise.

3. The method of claim 2 wherein the commercial enterprise provides at least one of goods and services.

4. The method of claim 2 wherein the commercial enterprise at least includes the offering of goods for sale.

5. The method of claim 2 wherein the commercial enterprise at least includes the offering of at least one of building materials, construction tools, repair tools, household appliances, landscaping tools, landscaping materials, and interior furnishings.

6. The method of claim 1 wherein receiving at the sponsor website information regarding at least one property-related services provider includes receiving the information regarding the at least one property-related services provider at the sponsor website via an Internet.

7. The method of claim 1 wherein receiving at the sponsor website information regarding at least one property-related services provider includes receiving a password that corresponds to a particular property-related services provider.

8. The method of claim 7 wherein receiving a password that corresponds to a particular property-related services provider includes receiving a password that corresponds to a particular property-related services provider which password was previously provided to the property-related services provider on behalf of the sponsor.

9. The method of claim 1 wherein receiving at the sponsor website information regarding at least one property-related services provider includes receiving at the sponsor website information regarding at least one provider of realtor services.

10. The method of claim 9 wherein receiving at the sponsor website information regarding at least one property consumer as corresponds to the at least one property-related service provider includes receiving at the sponsor website information regarding at least one legal entity who comprises at least a potential customer of the provider of realtor services.

11. The method of claim 10 wherein receiving at the sponsor website information regarding at least one legal entity who comprises at least a potential customer of the provider of realtor services includes receiving at the sponsor website information regarding at least one legal entity who comprises a recent purchaser of real estate property.

12. The method of claim 1 wherein receiving at the sponsor website information regarding at least one property-related services provider includes receiving at the sponsor website information regarding one of:
at least one provider of realtor services;
at least one provider of home inspection services;
at least one provider of home mortgage services;
at least one provider of home repair services;
at least one provider of home insurance services.

13. The method of claim 1 wherein providing a promotion includes providing at the sponsor website an option to the at least one property-related services provider regarding delivery of the promotion to a recipient.

14. The method of claim 13 wherein providing an option regarding delivery includes providing at least an option regarding:
permitting local printing of information regarding the promotion as controlled by the property-related services provider; and
emailing information regarding the promotion to an identified recipient.

15. The method of claim 14 wherein the identified recipient automatically comprises the at least one property consumer.

16. The method of claim 1 wherein receiving at the sponsor website information regarding at least one property consumer as corresponds to the at least one property-related service provider includes receiving at the sponsor website information regarding a plurality of property consumers as corresponds to the at least one property-related service provider.

17. The method of claim 16 wherein providing a promotion includes providing a promotion for a plurality of the plurality of property consumers.

18. The method of claim 1 wherein providing a promotion includes providing a promotion that includes a unique identifier such that the promotion may only be used a predetermined number of times.

19. The method of claim 18 wherein providing a promotion that includes a unique identifier includes providing a promotion that includes a unique identifier such that the promotion may only be used a single time.

20. The method of claim 1 wherein providing a promotion includes providing to the property-related services provider a plurality of promotions to select from for a given property consumer.

21. The method of claim 1 wherein receiving at the sponsor website information regarding at least one property consumer as corresponds to the at least one property-related service provider includes receiving information regarding a property address that corresponds to the at least one property consumer.

22. The method of claim 21 wherein providing a promotion includes providing a promotion that:
at least identifies the at least one property-related services provider; and
corresponds to a consumer opportunity as offered by the sponsor at a particular identified location.

23. The method of claim 22 wherein providing a promotion that corresponds to a consumer opportunity as offered by the sponsor at a particular identified location includes automatically identifying the particular identified location as a function, at least in part, of the property address that corresponds to the at least one property consumer.

24. The method of claim 22 wherein providing a promotion that corresponds to a consumer opportunity as offered by the sponsor at a particular identified location includes providing a promotion that corresponds to a consumer opportunity as offered by the sponsor at a plurality of particularly identified locations.

25. The method of claim 1 wherein providing a promotion that corresponds to a consumer opportunity includes providing a promotion that includes a monetary discount as regards at least one of goods and services.

26. The method of claim 1 wherein receiving at a sponsor website information regarding at least one property-related services provider includes:
receiving at the sponsor website identifying information regarding the property-related services provider;
receiving at the sponsor website a request from the property-related services provider that the property-related service provider be provided with a password to permit access to the sponsor website.

27. The method of claim 26 and further comprising forwarding at least some of the identifying information for the property-related service provider to other individuals who already have authorized access to the sponsor website and inquiring of the other individuals regarding the property-related service provider.

28. The method of claim 27 and further comprising providing a sponsor website access password to the property-related service provider upon receiving a sufficient response from the other individuals regarding the property-related service provider.

29. The method of claim 1 and further comprising:
receiving information regarding a tendered coupon.

30. The method of claim 29 and further comprising:
determining whether to authorize acceptance of the tendered coupon.

31. The method of claim 30 and further comprising:
providing a message that corresponds to an acceptance of the tendered coupon.

32. The method of claim 1 and further comprising:
at the sponsor website:
receiving information regarding a tendered coupon;
determining whether to authorize acceptance of the tendered coupon;
providing a message that corresponds to an acceptance of the tendered coupon.

33. A website comprising:
a log-in entry facility such that property-related services providers can log-in and gain access to at least certain areas of the website;
a new client entry facility operably coupled to the log-in entry facility such that information regarding a new client can be submitted to the website;
a client listing operably coupled to the new client entry facility;
a promotion selection facility operably coupled to the client listing such that at least one promotion selection as offered by a sponsor other than the property-related services providers can be correlated to at least one client in the client listing;
a consumer opportunity facility operably coupled to the promotion selection facility and having an output comprising a consumer opportunity delivery platform that includes both a consumer opportunity as offered by the sponsor for a client and at least identifying information regarding at least one of the property-related services providers.

34. The website of claim 33 wherein the consumer opportunity delivery platform comprises a coupon.

35. A method comprising:
receiving at a sponsor website information regarding at least one services provider;
receiving at the sponsor website information regarding at least one potential consumer as corresponds to the at least one service provider;
providing a promotion that:
at least identifies the at least one services provider; and
corresponds to a consumer opportunity as offered by a sponsor of the sponsor website.
